(19) United States
(12) Patent Application Publication
(10) Pub. No.: US 2010/0151865 A1
(43) Pub. Date: Jun. 17, 2010

(54) Interference Reduction in High-Speed Wireless Data Networks

(75) Inventors: William O. Camp, JR., Chapel Hill, NC (US); Leland Scott Bloebaum, Cary, NC (US)

Correspondence Address: COATS & BENNETT/SONY ERICSSON, 1400 CRESCENT GREEN, SUITE 300, CARY, NC, 27518, US

(73) Assignee: Sony Ericsson Mobile Communications AB, Lund (SE)

(21) Appl. No.: 12/332,650

(22) Filed: Dec. 11, 2008

(51) Int. Cl. H04W 40/00

(52) U.S. Cl. 455/445

(57) ABSTRACT

Methods, apparatus, and systems are described, in which mobile stations in gaps between conventional cells obtain access to high speed data services by initiating an ad hoc, peer-to-peer connection with an intermediary mobile station and transmitting an access request message to the intermediary mobile station for relaying to a nearby base station. Upon receiving such an access request, a base station determines the approximate location of the mobile station, estimates an angular direction from the base station to the mobile station, and forms a directed antenna beam aimed towards the mobile station for transmission of high speed data to the mobile station. Corresponding techniques in which a base station initiates the establishment of a high speed data link are also disclosed.

### BACKGROUND

The present invention relates generally to wireless communications networks and more particularly to techniques for reducing interference in such networks.

A conventional cellular wireless communication system typically includes a number of base stations scattered over a service area, each base station providing a geographic region of radio coverage known as a cell. The boundaries of the cell are effectively defined by the ability of the base station and mobile stations within the region to communicate with an acceptable quality level. Accordingly, a mobile station can communicate with a given base station only if it is within the cell served by that base station.

In order to provide complete coverage over a wide service area, locations of base stations are conventionally selected so that the cells overlap, thus avoiding areas where no coverage at all is available. This is shown in FIG. 1, which is a simplified view of the coverage provided by seven base stations A-G. In the figure, each base station provides a generally circular coverage area. Of course, in a real-world setting, the actual coverage area for a given cell is not likely to be perfectly circular; nor is the cell shape likely to be the perfect hexagonal shape used in much theoretical analysis of cell systems. Instead, the cell outline generally will be somewhat irregular, as radio signal propagation between a base station and a mobile station will vary based on the topography of the region, the density and/or types of construction in the region, and so on. Further, many conventional cellular systems employ cell sectorization, where the cell is divided into three or more sectors, each of which is served by a directional sector antenna. This approach provides for greater frequency re-use (and concomitant increased capacity), and also allows increased flexibility in controlling the shape of a given cell. However, when the multiple sectors are considered together, a multi-sectored cell site provides a generally circular coverage area, just as the omni-directional cell site does.

The conventional arrangement of cells pictured in FIG. 1 results in a system where each cell has a small, interference-free region in the center, and an outer region in which transmissions from the base station to the mobile station can overlap with transmissions from one or more neighboring base stations. In these areas of signal overlap, transmissions from adjacent base stations will thus appear as interference, particularly in systems where the same transmission frequencies are used in each cell.

In order to deal with this problem, conventional cellular systems use various techniques, including the use of different transmission resources (e.g. different frequencies, different time slots, and/or different spreading codes) at neighboring base stations. Advanced receivers have also been developed to improve signal detection and decoding in the presence of interference. Another solution is simply to disallow communications at the very highest data rates between a base station and mobiles stations at or near the cell boundaries. However, these conventional techniques all have disadvantages, including reductions in network capacity, increases in the complexity of the system, or inconsistent or uneven availability of services. Thus, there remains a need for continued improvements to existing wireless data networks.

### SUMMARY

If cell sites are located and controlled so that their omni-directional or multi-sector coverage areas do not overlap, or so that the overlapping regions are very small, mobile stations will experience little inter-cell interference, even at or near cell boundaries. Accordingly, complex interference mitigation efforts become more effective or even unnecessary. However, cell site arrangements of this sort will result in coverage gaps, between cells, that are not covered by the omni-directional or multi-sector antenna patterns of any cell. Mobile stations in these coverage gaps can nevertheless access high speed data services by initiating an ad hoc, peer-to-peer connection with an intermediary mobile station, and transmitting an access request message to the intermediary mobile station for relaying to a nearby base station. Upon receiving such an access request, a base station can determine the approximate location of the mobile station, either from data in the access request or by other means, and estimate an angular direction from the base station to the mobile station. The base station then forms a directed antenna beam aimed towards the mobile station and transmits high speed data via the directed antenna beam. This approach minimizes interference to other mobile stations, as most mobile stations can be served with conventional, but non-overlapping cell patterns, while only those mobile stations that fall in coverage gaps are served with directed antenna beams.

A wireless communications link between a base station and an out-of-coverage mobile station can be initiated by the base station as well. In this scenario, a base station transmits a paging message to an in-range intermediary mobile station, for relaying to the target mobile station. The paging message may pass through one or more additional intermediaries before reaching the target mobile station, in some cases. Upon receipt of the paging message, the mobile station responds with an access request message, in a similar manner to that described above, thus notifying the base station that the mobile station has been found. The base station again determines the approximate location of the mobile station, e.g., using GPS-derived location data included in the access request, sets up a directed antenna beam, and transmits high speed data to the mobile station. Other embodiments of the invention employ searching techniques for determining the direction of the mobile station, in which a directed antenna beam is swept or stepped through a range of angles in search of a beacon signal transmitted by the mobile station.

Thus, an exemplary method for establishing a wireless communications link between a base station and a first mobile station comprises receiving, at the base station, a wireless transmission from a second mobile station, the wireless transmission comprising an access request originating from a first mobile station and relayed by at least the second mobile station. An estimated angular direction from the base station to the first mobile station is determined, and data is transmitted to the first mobile station at a first data rate, using a first directional antenna beam directed according to the estimated angular direction.

In some embodiments, the wireless transmission from the second mobile station is received at a second data rate that is lower than the first data rate. In some embodiments, the access request comprises location data for the first mobile station, in which case determining the estimated angular direction from the base station to the first mobile station may comprise calculating the estimated angular direction based on the location data and known location information for the base station. In other embodiments, determining the estimated angular direction from the base station to the first mobile station comprises searching for an uplink beacon signal transmitted by the first mobile station, using a plurality of antenna beam directions, and determining a direction for the first directional antenna beam based on said searching. In some of these latter embodiments, determining a direction for the first directional antenna beam may comprise selecting a best one of the plurality of antenna beam directions, based on a received uplink signal quality for the best one of the plurality of antenna beam directions, while in others determining a direction for the first directional antenna beam may instead comprise interpolating the direction based on received uplink signal quality for two or more of the plurality of antenna beam directions.

Some embodiments of the above described methods include an initial transmission of a paging message for the first mobile station to the second mobile station, for relaying to the first mobile station, such that the access request is received in response to the paging message. In some of these embodiments, determining the estimated angular direction from the base station to the first mobile station may comprise searching for an uplink beacon signal transmitted by the first mobile station, using a plurality of antenna beam directions, and determining a direction for the first directional antenna beam based on said searching.

Various embodiments of the above described methods further include receiving data from the first mobile station, using a second directional antenna beam directed according to the estimated angular direction. Some embodiments further comprise estimating a revised estimated angular direction from the base station to the first mobile station and adjusting the first directional antenna beam according to the revised estimated angular direction.

Embodiments of the present invention also include wireless base stations and mobile stations configured to implement one or more of the techniques described above. For instance, an exemplary wireless base station comprises a receiver section configured to receive and process a wireless transmission from a first mobile station, the wireless transmission comprising an access request originating from a second mobile station and relayed to the wireless base station by at least the first mobile station, a control circuit configured to determine an estimated angular direction from the base station to the second mobile station and to direct a first directional antenna beam according to the estimated angular direction, and a transmitter section configured to transmit data to the second mobile station at a first data rate, using the first directional antenna beam.

In some embodiments, the receiver section is configured to receive and process the wireless transmission from the first mobile station at a second data rate that is lower than the first data rate. In some embodiments, the access request comprises location data for the second mobile station, in which case the control circuit is configured to determine the estimated angular direction from the base station to the second mobile station by calculating the estimated angular direction based on the location data and known location information for the base station. In these and/or other embodiments, the control circuit may be configured to determine the estimated angular direction from the base station to the first mobile station by searching for an uplink signal from the second mobile station using the receiver section and a plurality of antenna beam directions, and to determine a direction for the first directional antenna beam based on said searching. In some of these latter embodiments, the control circuit is configured to determine the direction for the first directional antenna beam by selecting a best one of the plurality of antenna beam directions, based on a received uplink signal quality for the best one of the plurality of antenna beam directions, while in others the control circuit is configured to determine the direction for the first directional antenna beam by interpolating the direction based on received uplink signal quality for two or more of the plurality of antenna beam directions.

Some of the above described wireless base stations may include a control circuit that is further configured to transmit to the first mobile station, using the transmitter section, a paging message for relaying to the second mobile station. In some of these embodiments, the control circuit is configured to determine the estimated angular direction from the base station to the first mobile station by searching for an uplink signal from the second mobile station using the receiver section and a plurality of antenna beam directions, and to determine a direction for the first directional antenna beam based on said searching.

In various of the above embodiments, the control circuit is configured to direct a second directional antenna beam according to the estimated angular direction, and the receiver section is configured to receive data from the second mobile station using the second directional antenna beam. In some embodiments, the control circuit is further configured to estimate a revised estimated angular direction from the base station to the first mobile station and to adjust the first directional antenna beam according to the revised estimated angular direction.

An exemplary mobile station, according to some embodiments of the invention, comprises a transmitter circuit, a control circuit configured to transmit an access request to a second mobile station, using the transmitter section, for relaying to a base station, and a receiver circuit configured to receive a high-speed data transmission directly from the base station in response to the access request. Some embodiments further include a position-determining circuit, so that the control circuit may include location data derived by the position-determining circuit in the access request. The position-determining circuit in these embodiments may comprise a Global Positioning System receiver.

In some embodiments, a mobile station includes a control circuit that is further configured to transmit an uplink beacon signal, using the transmitter circuit, after transmitting the access request, for use by the base station in determining an angular direction from the base station to the first mobile station.

Corresponding methods that may be implemented in one or more of the mobile stations discussed above include a method of establishing a wireless communications link between a first mobile station and a base station, the method comprising transmitting an access request from a first mobile station to a second mobile station, for relaying to the base station, and receiving, at the first mobile station, in response to the access request, a high-speed data transmission directly from the base station. Some embodiments of this method may further include determining, at the first mobile station, a location for the first mobile station, and including location data corresponding to the location in the access request transmitted to the second mobile station. These and other embodiments may also include first receiving a paging message directly from the second mobile station, the paging message originating at the base station, such that transmitting the access request is in response to the paging message.

Of course, those skilled in the art will appreciate that the present invention is not limited to the above contexts or examples, and will recognize additional features and advantages upon reading the following detailed description and upon viewing the accompanying drawings.

### BRIEF DESCRIPTION OF THE DRAWINGS

FIG. 1 is a simplified schematic diagram illustrating radio coverage areas of cells in a conventional wireless network.

FIG. 2 illustrates an alternative to the conventional network of FIG. 1, in which coverage area is not overlapping.

FIG. 3 illustrates a wireless network in which directional antenna beams are overlaid on cells,

FIG. 4 is a block diagram for a wireless base station according to some embodiments of the present invention.

FIG. 5 is a block diagram for a mobile station according to some embodiments of the present invention.

FIG. 6 is a combined process flow and message flow diagram illustrating an exemplary method for establishing a wireless communications link between a base station and a mobile station.

FIG. 7 is another process flow and message flow diagram illustrating another method for establishing a wireless communications link according to some embodiments of the present invention.

### DETAILED DESCRIPTION

The difficulties in designing a low-interference wireless communications network are exacerbated by the various technologies now available for supporting very high data rate wireless links. If a cellular data communications system uses power levels necessary for maintaining communication at a very high data rate and uses conventional cell layouts, e.g., based on the conventional tri-sectored antenna system, the interference levels to other terminals and base stations can be excessive for a major portion of the coverage area.

One approach to reducing such interference is simply to reduce the transmitted power levels and/or to increase the size of the cell. FIG. 2 provides a simplified illustration of a wireless network in which the transmission power from base stations H-N has been reduced so that the coverage areas do not overlap. Although this reduces the potential for interference over much of the coverage area, substantial gaps in coverage are created between the cells.

U.S. Pat. No. 6,473,617 to Larsen et al. (hereinafter “the ‘617 patent’) describes a wireless network which may be operated according to the network layout of FIG. 2, i.e., a layout in which gaps in coverage are allowed in order to minimize or eliminate zones of interference between base stations. The entire contents of the '617 patent are incorporated by reference herein, for the purposes of providing background and context for the discussion that follows. In the system described in the '617 patent, a first mobile station located in one of the coverage gaps (called “zones of reduced coverage” in the '617 patent) communicates with a base station by sending and receiving data messages via at least one intermediary (a “relay station’), which may be another mobile station that is within the coverage area of a base station and within communications range of the first mobile station.

Although the system described in the '617 patent permits the base stations to be operated in such a manner as to eliminate interference in all or most of the coverage area, it does so by requiring mobile stations to directly share resources with one another in order to provide complete system coverage. This approach may often be unsuitable for high data rate communication links, however, since the sharing of resources limits the data bandwidth available to an intermediary for its own communications needs. Furthermore, the relatively high power levels needed for high data rate communications may increase the levels of mobile-to-mobile interference to unacceptable levels.

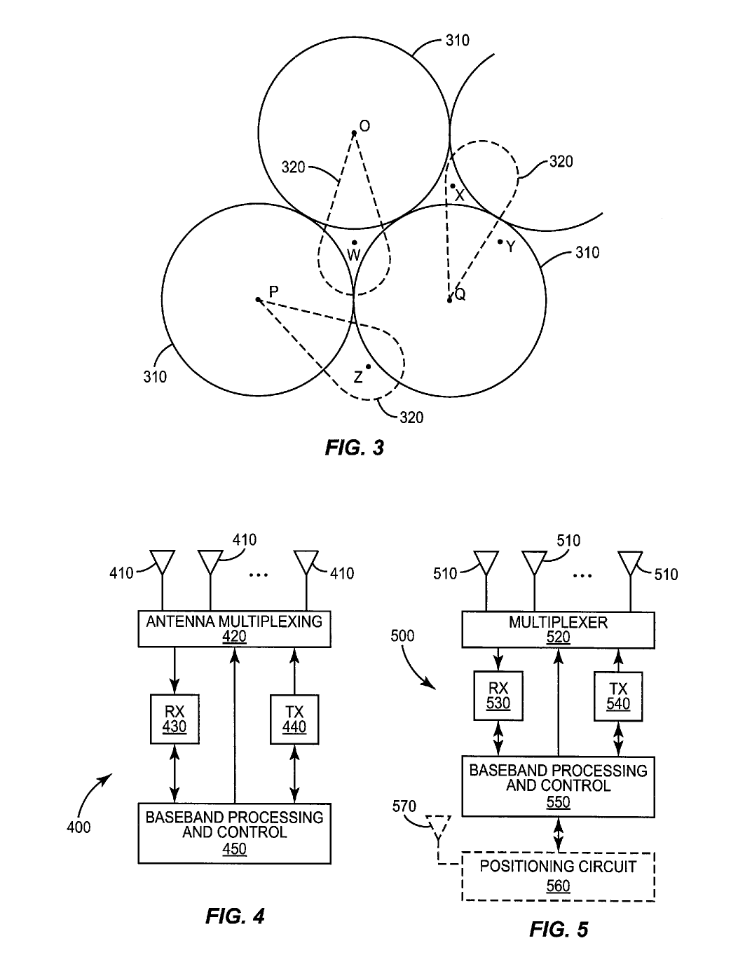

FIG. 3 provides a simplified illustration of a cellular network layout according to some embodiments of the present invention. Base stations O, P, and Q each provide omni-directional (or multi-sectored) wireless data coverage to cells 310. In the illustrated layout, the coverage areas of cells 310 are designed so that they are contiguous but do not substantially overlap. Other layouts may include larger or smaller gaps between the coverage areas; larger gaps will generally reduce interference even further. The lack of overlapping coverage reduces the potential for interference from neighboring systems, thus allowing communication services at the maximum data rate offered by the system to be made available to any mobile station within the cell boundary. For instance, base station Q can provide high data rate service to mobile station Y, even though mobile station Y is located close to the edge of the cell 310 served by base station Q. On the other hand, none of base stations O, P, or Q is able to provide the highest data rate coverage to any of mobile stations W, X, or Z through conventional means, as each of these mobile stations is located in a coverage gap.

Instead, high data rate coverage is provided to mobile stations W, X, and Z via directional antenna beams 320 originating at base stations O, Q, and P, respectively. Although each base station is the source of a single directional antenna beam 320 in FIG. 3, those skilled in the art will appreciate that a single base station can be arranged to provide two or more directional antenna beams, to serve multiple mobile stations falling outside the range of the base station's omni-directional or multi-sectored antenna system. Those skilled in the art will further appreciate that various techniques for forming a directed antenna beam are well known, including the use of high-gain antenna structures, coordinated transmissions from an array of antenna elements, mechanically steered antennas, electrically steered antennas (e.g., phased-array antennas), and the like.

Importantly, it is not necessary for the cellular data communications system to use directional antennas for all aspects of the communication. Such an approach would be unnecessarily complex, requiring the system to maintain many beams for full area coverage. Instead, mobile stations well within the range of the base station's normal omni-directional or multi-sectored coverage can be fully served through conventional means. For instance, referring once more to FIG. 3, mobile station Y can be fully served by base station Q according to conventional approaches. Nearby mobile station X, on the other hand, is selectively provided with high-speed data service through a directed antenna beam 320, since mobile station X is outside the coverage area 310 of base station O.

FIG. 4 is a simplified block diagram illustrating functional elements of a wireless base station 400, which is adapted to support the use of directed antenna beams as well as conventional omni-directional or sectored antenna configurations. In the pictured configuration, base station 400 includes a plurality of antenna elements 410; an antenna multiplexing circuit 420 allows one or more of these antenna elements 410 to be connected to each of a receiver circuit 430 and a transmitter circuit 440, which are each in turn connected to baseband processing and control circuit 450.

Those skilled in the art will appreciate that a variety of antenna multiplexing configurations are possible. Thus, in some embodiments, one or more antenna elements 410 may be shared by receiver circuit 430 and transmitter circuit 440, and connected to these circuits by a multiplexing filter (e.g., in the case of a frequency-division duplexing system) or by a switch (e.g., in the case of a time-division duplexing system). In other embodiments, different antenna elements 410 may be allocated to each of the receiver circuit 430 and the transmitter circuit 440. In some embodiments, antenna multiplexing circuit 420 may include one or more phase-shifters or delay units, so that two or more antenna elements 410 may be connected to receiver circuit 430 and/or transmitter circuit 440 with a pre-determined or variable relative phase relationship, so that a directed antenna beam is formed. In some of these embodiments, control signals from baseband processing and control circuit 450 are used to configure the antenna multiplexing circuit 420, such as to assign antenna elements 410 to the receiver circuit 430 and transmitter circuit 440 from among the available antenna elements, to combine signals from two or more antenna elements 410 according to a pre-determined or controllable phase relationship, so as to electrically “steer” a directed antenna beam, and/or to control one or more mechanical steering elements to point a directed antenna beam in a desired direction.

Similarly, those skilled in the art will appreciate that the inventive techniques disclosed herein may be applied to any of a variety of wireless communication systems, including but not limited to systems that use Time-Division Multiple Access (TDMA), Code-Division Multiple Access (CDMA), Orthogonal Frequency-Division Multiple Access (OFDMA), or Single Carrier Frequency-Division Multiple Access (SC-FDMA) technologies. Thus, receiver circuit 430 and transmitter circuit 440 may each comprise a variety of conventional radio-frequency, analog, and digital components, including, for example, filters, switches, low-noise amplifiers, power amplifiers, mixers, oscillators, phase-locked loop circuits, and the like, arranged according to well known techniques to process and condition signals received from one or more of antenna elements 410 and signals to be transmitted by one or more of antenna elements 410. The design of various arrangements of these components to comply with wireless communication standards and/or other technical requirements is well known to those skilled in the art; the details of these designs are not important to a full understanding of the present invention and are thus not provided here.

Likewise, baseband processing and control circuit 450 may comprise one or more analog and/or digital circuits configured to process baseband signals received from receiver circuit 430 and baseband signals to be supplied to transmitter circuit 440, again according to well known signal conditioning and processing techniques. Thus, for instance, baseband processing and control circuit 450 may include one or more microprocessors, microcontrollers, and/or digital signal processors, configured with appropriate software and/or firmware to detect, demodulate, and decode information from received signals, to format data and to provide modulation signals to transmitter circuit 440, to carry out appropriate signaling with corresponding mobiles stations, and the like. As with receiver circuits 430 and transmitter circuit 440, the design of baseband processing circuits appropriate to a given communication standard and/or to other wireless communication requirements is well known; thus only those details that are important to a full understanding of the present invention are included herein.

FIG. 5 is a simplified block diagram illustrating functional elements of a wireless mobile station 500, according to some embodiments of the present invention. In the pictured configuration, mobile station 500 includes two antenna elements 510; an antenna multiplexing circuit 520 allows one or both of these antenna elements 510 to be connected to each of a receiver circuit 530 and a transmitter circuit 540, which are each in turn connected to baseband processing and control circuit 550.

As was the case with base station 400, a variety of antenna multiplexing configurations are possible in a mobile station, although a mobile station is likely to include fewer antenna elements than its corresponding base station, and is less likely to support directed antenna beams. Nevertheless, some embodiments of mobile station 500 may support multiple-input multiple-output (MIMO) schemes, for example, thus requiring two or more antenna elements for receive and/or transmit operation. Thus, in some embodiments, one or both antenna elements 510 of mobile station 500 may be shared by receiver circuit 530 and/or transmitter circuit 540, and connected to these circuits by a multiplexing filter (e.g., in the case of a frequency-division duplexing system) or by a switch (e.g., in the case of a time-division duplexing system). Embodiments are possible in which a single antenna element 510 is allocated to each of the receiver circuit 530 and the transmitter circuit 540, as are embodiments in which only one of the receiver circuit 530 or transmitter circuit 540 uses both antenna elements 510. In some embodiments, control signals from baseband processing and control circuit 550 are used to configure the antenna multiplexing circuit 520, such as to selectively connect antenna elements 510 to the receiver circuit 530 and transmitter circuit 540 according to a time-division duplexing scheme and/or according to a selective antenna combining scheme.

As with the base station 400, mobile station 500 may operate in one or more of a variety of wireless communication systems, including but not limited to systems that use Time-Division Multiple Access (TDMA), Code-Division Multiple Access (CDMA), Orthogonal Frequency-Division Multiple Access (OFDMA), or Single Carrier Frequency-Division Multiple Access (SC-FDMA) technologies. Thus, receiver circuit 530 and transmitter circuit 540 may each comprise a variety of conventional radio-frequency, analog, and digital components, including, for example, filters, switches, low-noise amplifiers, power amplifiers, mixers, oscillators, phase-locked loop circuits, and the like, arranged according to well known techniques to process and condition signals received from antenna elements 510 and signals to be transmitted by antenna elements 510. Again, the design of various arrangements of these components to comply with wireless communication standards and/or other technical requirements is known to those skilled in the art; as the details of these designs are not important to a full understanding of the present invention, they are not provided here.

Likewise, baseband processing and control circuit 550 may comprise one or more analog and/or digital circuits configured to process baseband signals received from receiver circuit 530 and baseband signals to be supplied to transmitter circuit 540, again according to well known signal conditioning and processing techniques. Thus, for instance, baseband processing and control circuit 550 may include one or more microprocessors, microcontrollers, and/or digital signal processors, configured with appropriate software and/or firmware to detect and/or demodulate information from received signals, to provide modulation signals to transmitter circuit 550, to carry out appropriate signaling with corresponding mobiles stations, and the like. As with receiver circuits 530 and transmitter circuit 540, the design of baseband processing circuits for mobile stations that are appropriate to a given communication standard and/or to other wireless communication requirements is well known; only those details that are important to a full understanding of the present invention are included herein. Of course, in contrast to the components typically employed in base station 400, the components of mobile station 500 will often be adapted for use in a lightweight, power-efficient, portable unit, although heavier duty and/or fixed implementations of mobile station 500 are also possible.

As pictured in FIG. 5, mobile station 500 optionally comprises a positioning circuit 560, connected to antenna 570. In some embodiments, positioning circuit 560 may comprise a Global Positioning System (GPS) receiver, which in turn may operate with or without assistance data received from a terrestrial wireless network, in various embodiments, according to a so-called assisted-GPS or aided-GPS scheme. In other embodiments, positioning circuit 560 may be configured to process signals received from one or more cellular base stations or other terrestrial transmitters and to determine a position for the mobile station 500 based on triangulation calculations; in other embodiments positioning circuit 560 may be configured to perform timing measurements for several received signals and to transmit these timing measurements to a node in the wireless network node for determination of the mobile station's position, such as according to the positioning techniques known as Enhanced Observed Time Difference (E-OTD).

In addition to being configured for communication with base station 400, mobile station 500 is further configured for mobile-to-mobile, ad hoc communication with other similarly configured mobile stations. Thus, mobile station 500 is capable of transmitting a message to another mobile station, for relaying to a base station (or another mobile station). Similarly, mobile station 500 is capable of receiving a message from another mobile station. In some cases this received message may be targeted to the mobile station by an out-of-range base station 400, and arrive at mobile station 500 after being relayed by one or more intermediate mobile stations. In other cases, the received message may have been originated by another mobile station, and passed to mobile station 500 for relaying to an in-range base station or to another mobile station.

Various methods and apparatus for establishing ad hoc, peer-to-peer links between mobile stations are well known, and are not described in detail herein. Those skilled in the art will appreciate that some embodiments of mobile station 500 may re-use all or a portion of the circuitry used in communicating with base station 400 for ad hoc communication with peer mobile stations. Thus, some systems may use the same wireless standard and/or frequency band(s) for operating in cellular and ad hoc modes. In a frequency-division duplexing system, this may require transmitting in a frequency band normally designated for reception by mobile stations, or receiving in a frequency band normally designated for transmitting by mobile stations, or both. In a time-division duplexing system, this may simply require transmitting in and/or monitoring one or more time slots that are currently unused by an in-range base station or mobile station. In other embodiments, a different wireless standard and/or different frequency band may be used for operation in the cellular mode and ad hoc modes.

As noted above, a wireless network may be configured to overcome coverage gaps in a cellular system layout through the relaying of data from one mobile station to another. However, this approach requires mobiles stations to directly share resources with one another. Since this approach limits the data bandwidth available to an intermediary for its own communications needs, this approach may be unsuitable for high data rate communication links. The systems described herein solve this problem by selectively combining an ad hoc relay mode with the use of directed antenna beams. Accordingly, ad hoc relays, which may use relatively low data rate links, are used to establish an initial link between an out-of-range mobile station and a base station. Once the initial link is established, a directed antenna beam can be set up and aimed at the out-of-range mobile station. With the extra range of the directed antenna beam, the base station can support a high data rate link, without causing excessive interference to an entire cell.

To properly aim the directed antenna beam, the base station must generally determine the approximate angular position of the mobile station. Any of several techniques may be used to determine this position. In some embodiments, for example, an out-of-range mobile station determines its own position (using GPS, for example, or some other autonomous positioning technique) and sends an access request to the base station via one or more intermediary mobile stations. The access request includes location data for the mobile station; the base station can use this location data and known location information for the base station to calculate an estimated angular direction for the mobile station. Once the estimated angular direction is determined, an appropriate directed antenna beam can be established. In those systems where the antenna beam may be electronically or mechanically steered to a high degree of precision, the antenna beam can be centered on the estimated angular beam. Other systems might have a limited number of possible antenna beam directions; these systems might simply select a best one of these directions based on the estimated angular direction for the mobile station.

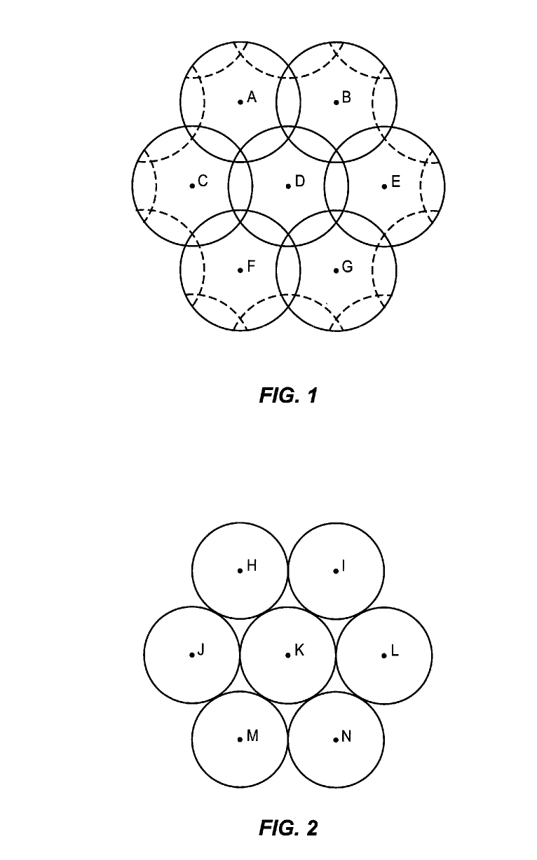

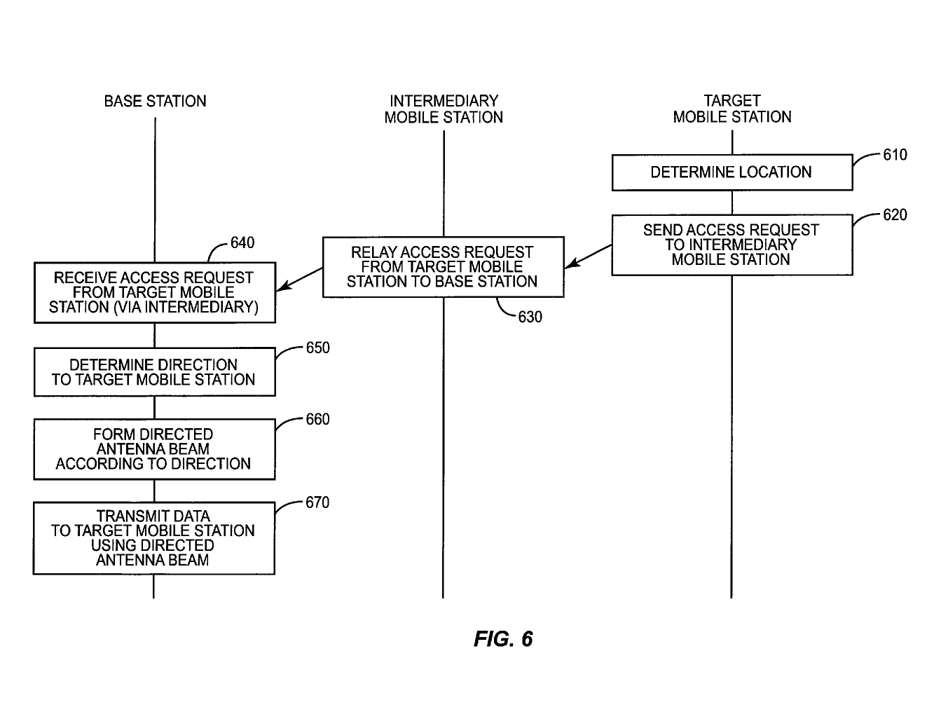

FIG. 6 illustrates an exemplary method for establishing a high-speed data connection between a base station and an out-of-range mobile station, such as FIG. 1's base station Q and mobile station X. In the scenario pictured in FIG. 6, the target mobile station (e.g., mobile station X) is initiating the connection.

Accordingly, the target mobile station determines its location, as shown at block 610. As noted above, this may be done using a GPS receiver, which may or may not use assistance data. In other embodiments, terrestrial radio signals may be used to determine location; in still other embodiments, information from terrestrial radio signals and satellite signals may be combined to estimate the mobile station's positioning. In yet other embodiments, location data received from beacon transmitters in the proximity of the mobile station might be used. Dead-reckoning techniques might be combined with one or more of the above techniques, in some embodiments, to improve position estimates and/or to overcome the temporary loss of one or more radio signals.

As shown at block 620, the target mobile station sends an access request to an intermediary mobile station, using an ad hoc, peer-to-peer mode as discussed above. The access request includes an identifier for the target mobile station, and in some embodiments may include may include location data corresponding to the mobile station's position. The access request may also include other information useful for establishing a high-speed data link with a base station, such as one or more parameters indicating a type of service desired or a required level of service (e.g., a minimum data rate), or one or more parameters indicating communication capabilities of the mobile station (e.g., data rates, modulation schemes, and/or frequency bands supported by the mobile station.

As shown at block 630, the access request is relayed to a base station by an intermediary mobile station within range of the base station (e.g., mobile station Y, in FIG. 3). In the scenario pictured in FIG. 6, only a single intermediary mobile station is involved in the relay. In other scenarios, the access request may be transferred through two or more intermediary mobile stations before it is transferred to a base station.

In any event, the base station ultimately receives the access request from the target mobile station (via at least one intermediary), as shown at block 640. The relay of the access request from the last intermediary mobile station may be according to any of a variety of protocols and/or signaling schemes. For example, the access request message might be re-formatted as a message for a Short Message Service (SMS) and transmitted to the base station. Alternatively, the access request message might be formatted as an Internet Protocol (IP) packet addressed to a pre-determined IP and/or to a pre-determined port, or the content of the access request message might be transmitted on a control channel according to some other pre-determined format.

After receiving the access request, the base station determines an estimated angular direction to the target mobile station, as shown at block 650. If the access request includes location data for the mobile station, this may be as simple as calculating an angular direction using the received location data and known location information for the base station. In other embodiments, location information for the mobile station is requested from a location service, within the cellular system or separate from it, that can either obtain a real-time location estimate for the mobile station or maintains up-to-date location information for the mobile station. This location service may have access to one or more network-based positioning technologies, for example, such as E-OTD techniques, Time-Difference-of-Arrival (TDOA), or the like. In any event, location information from the location service is then used with known location information for the base station to calculate an estimated angular direction for the mobile station. In still other embodiments, the base station may determine an estimated angular direction for the mobile station by searching for a beacon signal from the mobile station; this approach will be discussed in more detail below.

Once the base station has determined an estimated angular direction for the mobile station, it can then form a directed antenna beam according to that estimate, as shown at block 660. As noted above, in some embodiments, this may comprise electronic steering of an antenna beam, such as with a phased array of antenna elements. In others, a narrow-beam antenna element may be mechanically steered. Other systems may utilize an assortment of fixed narrow beam antennas, arranged at regularly spaced angles; in these systems a single best antenna direction might be selected, or two (or more) fixed antenna beams combined to form a composite directed antenna beam. In any case, the directed antenna beam is then used to transmit high-speed data to the target mobile station, as shown at blocks 670 and 680. High-speed data may be received from the target mobile station as well, using the same antenna beam or a second antenna beam directed according to the estimated angular direction.

Those skilled in the art will appreciate that some position-determining techniques utilize location assistance information that is transmitted to a mobile station independently of the ranging signals used for the position calculation. For instance, an assisted-GPS system might include the transmission of location assistance information, via cellular base station transmitters, to mobile terminals. The location assistance information, which might include data identifying visible satellites, their expected approximate positions and timings, and the like, is used by the mobile station to speed up the position determination, to enable the mobile station to calculate a position using weaker signals than would otherwise be possible, or both.

As is clear from the scenarios discussed above, a mobile station seeking to establish a high data rate link may be out of range of a base station that would otherwise be a source of location assistance information. In some embodiments of the invention, this location assistance information is provided to the target mobile station by a peer mobile station (such as the intermediary mobile station discussed above) that has received it from a base station. In some cases, the location assistance data may be specifically addressed to the target mobile station, e.g., in response to an access request from the target, and transmitted to the intermediate base station for relay to the target. In other cases, the out-of-range mobile station may request and receive the location assistance information from a peer mobile station on an ad-hoc basis, and use the location assistance information to determine its position before sending an access request to the base station.

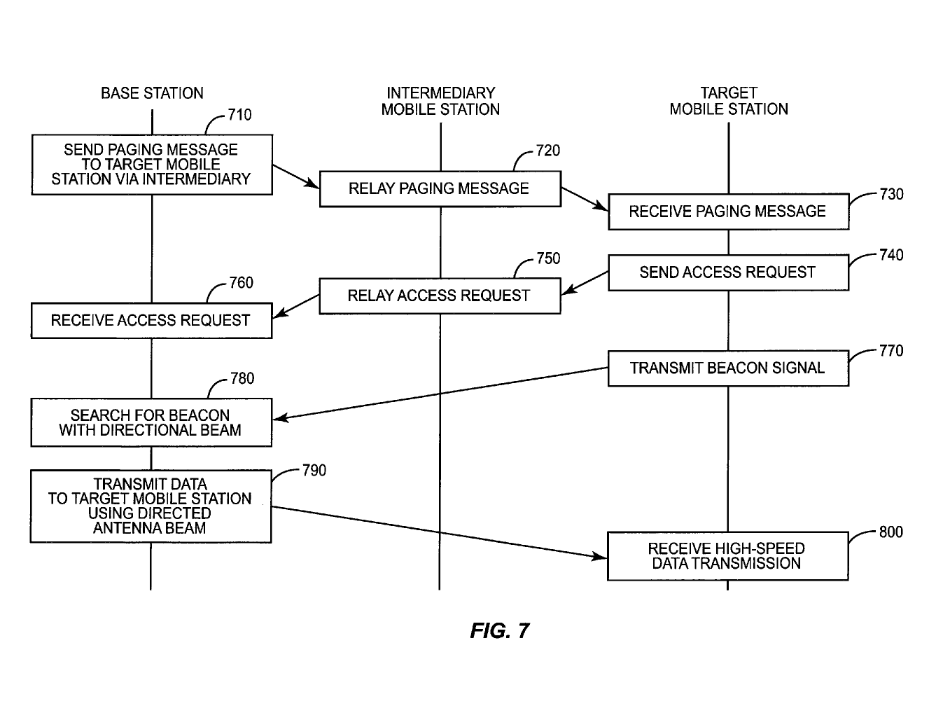

FIG. 7 illustrates another scenario in which a high-speed data link is established between a base station and a mobile station. In this case, the link is initiated by the base station, which transmits a paging message, targeted to an out-of-range mobile station, to an intermediary mobile station, as shown at block 710. The intermediary mobile station relays the paging message to the target mobile station, as shown at blocks 720 and 730; as suggested above, this relay may involve two or more intermediary mobile stations in some situations.

In response to the paging message, the target mobile station sends an access request back to the base station via the intermediate mobile station, as shown at blocks 740 and 750. In the pictured scenario, the base station receives the access requests from the same intermediary mobile station that it initially used for relaying the paging message; in other scenarios the access request might return to the base station via one or more different intermediary mobile stations. In some scenarios, an intermediary mobile station might relay the access request to a different base station from the one that initiated the paging message—in such a case the access request might be forwarded within the communications network to the initiating base station, or to another, more suitable base station (e.g., based on the location of the mobile station, capacity constraints at one or more base stations, or the like).

In the scenario illustrated in FIG. 7, it is assumed that the target mobile station is not capable of autonomously determining its own location. Thus, the access request message does not include location information. Of course, other embodiments or scenarios may involve GPS-equipped mobile stations, and may thus incorporate location data into the access request message.

In this scenario, however, the base station determines the location of the target mobile station using a beacon signal transmitted by the target mobile station, as shown at block 770. This beacon signal may be a continuous or periodic signal transmitted according to a pre-determined format and at a pre-determined frequency (or one of a pre-determined group of frequencies). Since the target mobile station is out of range of the base station's conventional omni-directional (or multi-sectored) antenna coverage, the base station is configured to search for the beacon using a directed antenna beam, as shown at block 780. In some embodiments, this search may comprise sweeping an electronically or mechanically steered antenna beam over a range of angles. In others, the base station may step through a series of fixed antenna beam directions to find the beacon signal. In either case, the base station searches for a pre-determined beacon signal (using, for example, correlation techniques), and estimates an angular direction for the mobile station based on the detection of that signal. An antenna beam is then directed to the mobile station, and high-speed data transmitted to the mobile station, as shown at blocks 790 and 800. Again, high-speed data may also be received from the mobile station, using the same antenna beam or a separate beam directed according to the estimated angular direction for the mobile station.

In some cases, the searching and beam direction processes may comprise determining a best one of a plurality of antenna beam directions, based on received uplink signal quality (e.g., signal strength) for the beacon signal. In some situations, the beacon signal may be detected on each of two or more directed antenna beams, or over a range of swept antenna beam directions; the antenna beam direction corresponding to the strongest signal may be selected. In other embodiments, a best antenna beam direction may be determined by interpolating between two or more stepped antenna beam directions, based on a received uplink signal quality (e.g., signal strength).

In either of the scenarios depicted in FIGS. 6 and 7, it may become necessary to adjust the direction of the directed antenna beam (or beams). For example, an adjustment may be necessary to compensate for motion of the target mobile station. Thus, in some embodiments of the present invention, the base station is configured to estimate a revised estimated angular direction from the base station to the mobile station and to adjust the directed antenna beam according to the revised estimated angular direction. In some embodiments, the revised estimated angular direction may be computed based on updated location information for the mobile station. This updated location information may be received directly from the mobile station or from a network-based positioning system, for example. In other embodiments, the estimated angular direction may be revised based on monitoring signal quality from (or to) the mobile station over a range of antenna beam directions. For example, in one embodiment, the antenna beam direction may be periodically adjusted in small increments from the initial direction, and the signal strength monitored to determine whether the new direction yields an improvement in signal strength.

Using the techniques described above, the interference from higher transmit power needed for high data rates is confined to a small portion of the coverage area. High-speed data service may be provided to close-in mobile stations using conventional omni-directional or multi-sectored antenna coverage, while high-speed service for distant mobiles, especially mobiles falling in “gaps” of the conventional coverage area, is provided via the directed beams.

In some embodiments, either the mobile station or base station can indicate to the other that a high-speed connection is no longer necessary, in which case the directed antenna beam is discontinued. Subsequent connections between the mobile station and the base station may be managed via the ad hoc mode until or unless the mobile station moves within the coverage of a conventional cell.

In some embodiments, the network can facilitate the resumption of the ad hoc mode at the termination of a high data rate session by transferring information about other terminals in the area to the mobile station. This information may be used by the mobile station to facilitate the detection of neighboring mobile stations and the rapid establishment of an ad hoc connection. As needed, the ad hoc connection may be used to resume the high-speed data connection to the base station.

Those skilled in the art will appreciate that various combinations of the various techniques discussed above for estimating a direction to a mobile station, adjusting a directed beam, initiating a connection, etc., may be implemented by mobile station 500 and base station 400. In particular, the specific scenarios depicted in FIGS. 6 and 7 are representative examples only; those skilled in the art will recognize that the discussion of several particular techniques in the mobile-originated context of FIG. 6 is applicable to the base station-originated context of FIG. 7, and vice versa.

Furthermore, those skilled in the art will appreciate that the techniques discussed herein may be implemented using any of a broad variety of mobile stations and base station configurations, having details different than those discussed earlier. In addition, those skilled in the art will appreciate that several of the functional elements of the base station 400 and mobile station 500 described above, including, but not limited to, the several functions of the base band processing and control circuits 450 and 550, may be implemented on one or more microcontrollers, microprocessors, or digital signal processors. Several of all of these functional elements may be implemented together, i.e., using a shared processor element, or one or more of the functional elements may be implemented separately, with appropriate hardware and/or software interfaces between the functional blocks. Several of these elements may be implemented on an application-specific integrated circuit (ASIC) designed for use in a mobile station and/or base station, which ASIC may include one or several programmable elements. Various functional elements of base station 400 and mobile station 500 may be provided through the use of dedicated hardware, on-board an ASIC or off, or may be implemented with hardware capable of executing software, in association with the appropriate software or firmware. Furthermore, those skilled in the art will appreciate that terms such as “processor,” “controller,” and “signal processing unit” do not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Those skilled in the art will appreciate the cost, performance, and maintenance tradeoffs inherent in these design choices.

The present invention may, of course, be carried out in other ways than those specifically set forth herein without departing from essential characteristics of the invention, and is limited only by the attached claims.

What is claimed is:

1. A method of establishing a wireless communications link between a base station and a first mobile station, the method comprising:
receiving, at the base station, a wireless transmission from a second mobile station, the wireless transmission comprising an access request originating from a first mobile station and relayed by at least the second mobile station;
determining an estimated angular direction from the base station to the first mobile station; and
transmitting data to the first mobile station at a first data rate using a first directional antenna beam directed according to the estimated angular direction.

2. The method of claim 1, wherein the wireless transmission from the second mobile station is received at a second data rate that is lower than the first data rate.

3. The method of claim 1, wherein the access request comprises location data for the first mobile station, and wherein determining the estimated angular direction from the base station to the first mobile station comprises calculating the estimated angular direction based on the location data and known location information for the base station.

4. The method of claim 1, wherein determining the estimated angular direction from the base station to the first mobile station comprises searching for an uplink beacon signal transmitted by the first mobile station, using a plurality of antenna beam directions, and determining a direction for the first directional antenna beam based on said searching.

5. The method of claim 4, wherein determining a direction for the first directional antenna beam comprises selecting a best one of the plurality of antenna beam directions, based on a received uplink signal quality for the best one of the plurality of antenna beam directions.

6. The method of claim 4, wherein determining a direction for the first directional antenna beam comprises interpolating the direction based on received uplink signal quality for two or more of the plurality of antenna beam directions.

7. The method of claim 1, wherein determining the estimated angular direction from the base station to the first mobile station comprises transmitting location assistance information to the second mobile station for relaying to the first mobile station.

8. The method of claim 1, further comprising first transmitting a paging message for the first mobile station to the second mobile station, for relaying to the first mobile station, wherein the access request is received in response to the paging message.

9. The method of claim 8, wherein determining the estimated angular direction from the base station to the first mobile station comprises searching for an uplink beacon signal transmitted by the first mobile station, using a plurality of antenna beam directions, and determining a direction for the first directional antenna beam based on said searching.

10. The method of claim 1, further comprising receiving data from the first mobile station using a second directional antenna beam directed according to the estimated angular direction.

11. The method of claim 1, further comprising estimating a revised estimated angular direction from the base station to the first mobile station and adjusting the first directional antenna beam according to the revised estimated angular direction.

12. A wireless base station, comprising:
a receiver section configured to receive and process a wireless transmission from a first mobile station, the wireless transmission comprising an access request originating from a second mobile station and relayed to the wireless base station by at least the first mobile station;
a control circuit configured to determine an estimated angular direction from the base station to the second mobile station and to direct a first directional antenna beam according to the estimated angular direction; and
a transmitter section configured to transmit data to the second mobile station at a first data rate, using the first directional antenna beam.

13. The wireless base station of claim 12, wherein the receiver section is configured to receive and process the wireless transmission from the first mobile station at a second data rate that is lower than the first data rate.

14. The wireless base station of claim 12, wherein the access request comprises location data for the second mobile station, and wherein the control circuit is configured to determine the estimated angular direction from the base station to the second mobile station by calculating the estimated angular direction based on the location data and known location information for the base station.

15. The wireless base station of claim 12, wherein the control circuit is configured to determine the estimated angular direction from the base station to the first mobile station by searching for an uplink signal from the second mobile station using the receiver section and a plurality of antenna beam directions, and to determine a direction for the first directional antenna beam based on said searching.

16. The wireless base station of claim 15, wherein the control circuit is configured to determine the direction for the first directional antenna beam by selecting a best one of the plurality of antenna beam directions, based on a received uplink signal quality for the best one of the plurality of antenna beam directions.

17. The wireless base station of claim 12, wherein the control circuit is configured to transmit to the first mobile station, using the transmitter section, a paging message for relaying to the second mobile station.

18. The wireless base station of claim 17, wherein the control circuit is configured to determine the estimated angular direction from the base station to the first mobile station by searching for an uplink signal from the second mobile station using the receiver section and a plurality of antenna beam directions, and to determine a direction for the first directional antenna beam based on said searching.

19. The wireless base station of claim 12, wherein the control circuit is configured to direct a second directional antenna beam according to the estimated angular direction, and wherein the receiver section is configured to receive data from the second mobile station using the second directional antenna beam.

20. The wireless base station of claim 12, wherein the control circuit is further configured to estimate a revised estimated angular direction from the base station to the first mobile station and to adjust the first directional antenna beam according to the revised estimated angular direction.

21. A first mobile station, comprising:
a transmitter circuit;
a control circuit configured to transmit an access request to a second mobile station, using the transmitter section, for relaying to a base station; and
a receiver circuit configured to receive a high-speed data transmission directly from the base station in response to the access request.

22. The first mobile station of claim 21, further comprising a position-determining circuit, wherein the control circuit is configured to include location data derived by the position-determining circuit in the access request.

23. The first mobile station of claim 22, wherein the receiver circuit is further configured to receive location assistance data from the second mobile station, and wherein the position-determining circuit is configured to derive the location data based on the location assistance data.

24. The first mobile station of claim 22, wherein the position-determining circuit comprises a Global Positioning System receiver.

25. The first mobile station of claim 21, wherein the control circuit is further configured to transmit an uplink beacon signal, using the transmitter circuit, after transmitting the access request, for use by the base station in determining an angular direction from the base station to the first mobile station.

26. A method of establishing a wireless communications link between a first mobile station and a base station, the method comprising:
transmitting an access request from a first mobile station to a second mobile station, for relaying to the base station; and
receiving, at the first mobile station, in response to the access request, a high-speed data transmission directly from the base station.

27. The method of claim 26, further comprising:
determining, at the first mobile station, a location for the first mobile station; and
including location data corresponding to the location in the access request transmitted to the second mobile station.

28. The method of claim 27, wherein determining the location for the first mobile station comprises receiving location assistance information from the second mobile station and calculating the location for the first mobile station based on the location assistance information.

29. The method of claim 26, further comprising first receiving a paging message directly from the second mobile station, the paging message originating at the base station, wherein transmitting the access request is in response to the paging message.
